(19) United States
(12) Patent Application Publication
(10) Pub. No.: US 2010/0236166 A1
(43) Pub. Date: Sep. 23, 2010

(54) Demoutable barrier for premises

(76) Inventor: Jason Tucker, Chatham (GB)

Correspondence Address: Ira S. Dorman, 330 Roberts Street, Suite 200, East Hartford, CT, 06108, US

(21) Appl. No.: 11/988,464

(22) PCT Filed: Jul. 4, 2006
(86) PCT No.: PCT/GB2006/002482

§ 371 Date: Jun. 1, 2010

(30) Foreign Application Priority Data
Jul. 12, 2005 (GB) 0514271.6

(51) Int. Cl. E06B 3/30

(52) U.S. Cl. 52/202

(57) ABSTRACT

A demountable barrier (8) for substantially preventing access of water into premises (2) through an access region (4) provided in a wall (6) of the premises. A frame member (10) has a longitudinal channel (20) in a first face (22) open towards the wall of the premises. A resilient membrane (30) is secured to the frame member and framed by the frame member and overlying and closing the longitudinal channel. A non-return air valve (28) extends to the longitudinal channel from a second face (24) of the frame member and is sealed through an aperture provided in the frame member. A compressible sealing member (38) is located between the frame member and the wall of the premises and pump means (40) provides pressurised air into the longitudinal channel through the non-return air valve, to effect ballooning of the resilient membrane overlying the longitudinal channel and compression of the compressible sealing member, whereby a substantially water-tight seal is effected between the frame member and the wall.

This invention relates to a demountable barrier for use with premises, such as domestic and/or commercial premises for substantially preventing or minimising access of air and/or water into the premises through an access region, such as a door, window, drain or airbrick, of the premises. In particular, the invention relates to such a barrier for preventing storm or flood water and/or high winds, such as of hurricane, tornado, whirlwind or gale force, from accessing premises through vulnerable access regions of premises.

Serious damage and destruction of buildings is increasingly occurring worldwide as a result of floods and storms. High winds, such as of hurricane, tornado, whirlwind or gale force can break down vulnerable access regions of buildings, such as doors and windows, and flood or storm water can access buildings through door or window regions or other apertures.

Many attempts have been made to provide barriers to protect such doors and windows, such as by nailing or screwing boards over the doors and windows or by providing permanent shutter means. Such arrangements are either expensive, inconvenient, unsightly and/or temporary and generally unsatisfactory in that they fail to provide an adequate seal against the hostile elements of air and/or water.

It is an object of the present invention to overcome or minimise this problem.

According to the present invention there is provided a demountable barrier for substantially preventing or minimising access of air and/or water into premises through an access region provided in a wall of the premises, the barrier comprising: a frame member adapted to be firmly secured to the wall of the premises and surrounding the access region, the frame member having a longitudinal channel therein in a first face thereof open towards the wall of the premises; a resilient membrane secured to the frame member and framed by the frame member and overlying and closing the longitudinal channel; at least one non-return air valve means extending to the longitudinal channel from a second face of the frame member and sealed through at least one aperture provided in the frame member; a compressible sealing member adapted to be located between the frame member and the wall of the premises; and pump means to provide pressurised air into the longitudinal channel through the at least one non-return air valve means, to effect ballooning of the resilient membrane overlying the longitudinal channel and compression of the compressible sealing member, whereby a substantially water- and/or air-tight seal is effected between the frame member and the wall.

The second face of the frame member may be opposite to the first face of the frame member.

The frame member may be of substantially rectangular form and may comprise metal, such as aluminium, the longitudinal channel being suitably formed by an extrusion process.

The frame member may be demountably secured to the wall of the premises by threaded fastener means, such as bolts, which may comprise expandable securing means and/or may incorporate wing nuts and/or may incorporate security locking means.

The resilient membrane may comprise a sheet of plastics material, such as polypropylene and may suitably have a thickness of from about 2.5 mm to about 3 mm.

The resilient membrane may be stretched over the frame member.

The resilient membrane may be secured to the frame member at either side of the longitudinal channel, such as by threaded fasteners, to substantially sealingly close the longitudinal channel.

The resilient membrane may be overlain by one or more strips, such as of metal, such as aluminium, where secured to the frame member, threaded fasteners being suitably provided extending through the one or more strips and the resilient membrane and into the frame member.

The at least one non-return air valve means may be substantially similar to air valve means provided for inflating vehicle tyres.

The pump means may comprise a manual or automated air pump, such as a pump provided for inflating vehicle tyres. The manual air pump may be a bicycle tyre pump or a foot-operated pump.

The compressible sealing member may comprise a natural or synthetic rubber material, such as neoprene, and suitably having a thickness of about 40 mm.

The external edge of the frame member may be chamfered. Additionally or alternatively, the external edge of the compressible sealing member may be chamfered.

Protective cover means may be provided for the demountable barrier and suitably formed of or from a relatively rigid sheet material, such as a plastics material, which may be reinforced with fibres, such as glass fibres, and/or vacuum formed or moulded, and may be provided of a box-like shape for enclosing the barrier. The protective cover means may be secured to the frame member of the barrier, for example by means of a mastic material, such as a silicone mastic material.

When the resilient membrane and/or the protective cover means comprises a non-transparent and/or non-translucent material, one or more transparent and/or translucent window-like panels, such as of a clear polycarbonate material, may be sealedly incorporated therein. A suitable thickness for the window-like panel of clear polycarbonate material incorporated in the protective cover means is about 12 mm.

When the access region of the premises has no wall of the premises below a lower edge region thereof, the frame member may be adapted to cooperate along a lower edge thereof with a strip-form member which is adapted to be sealedly secured to a base region of the premises below the access region. Such strip-form member may comprise metal, such as aluminium.

The premises may be a commercial or domestic building.

The access region may be a door, a window or other aperture in the premises.

By means of the demountable barrier of the present invention, water and/or air is substantially prevented from entering the premises through the access region of the premises. Such water may, for example be flood and/or storm water and such air may be of a high force and resulting, for example, from hurricanes, tornadoes, whirlwinds or gales.

For a better understanding of the present invention and to show more clearly how it may be carried into effect, reference will now be made by way of example to the accompanying drawings in which:

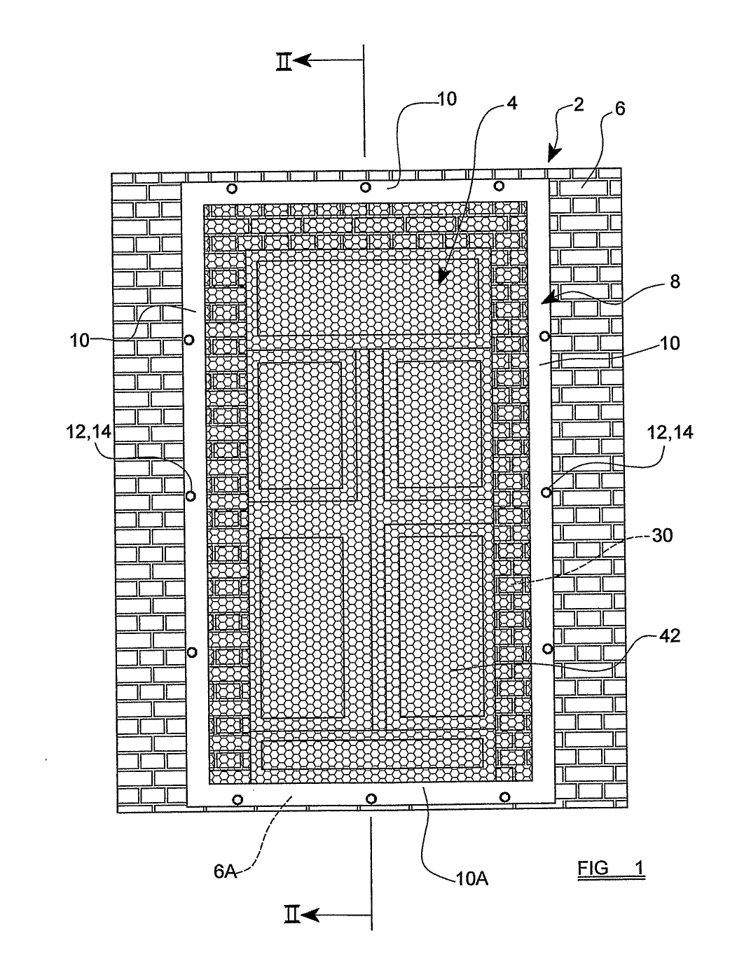

FIG. 1 is a plan view of premises having a door provided with an embodiment of a demountable barrier according to the present invention;

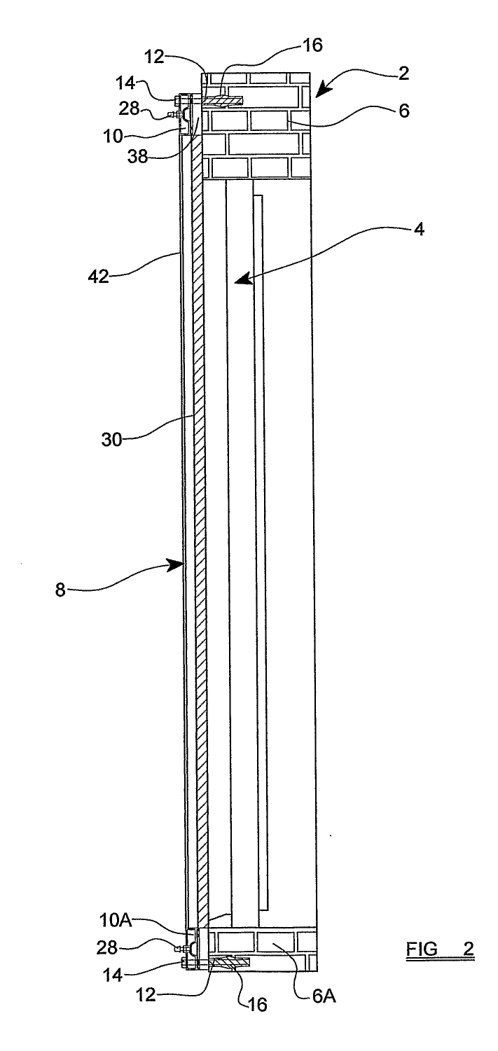

FIG. 2 is a cross-sectional view of the arrangement of FIG. 1;

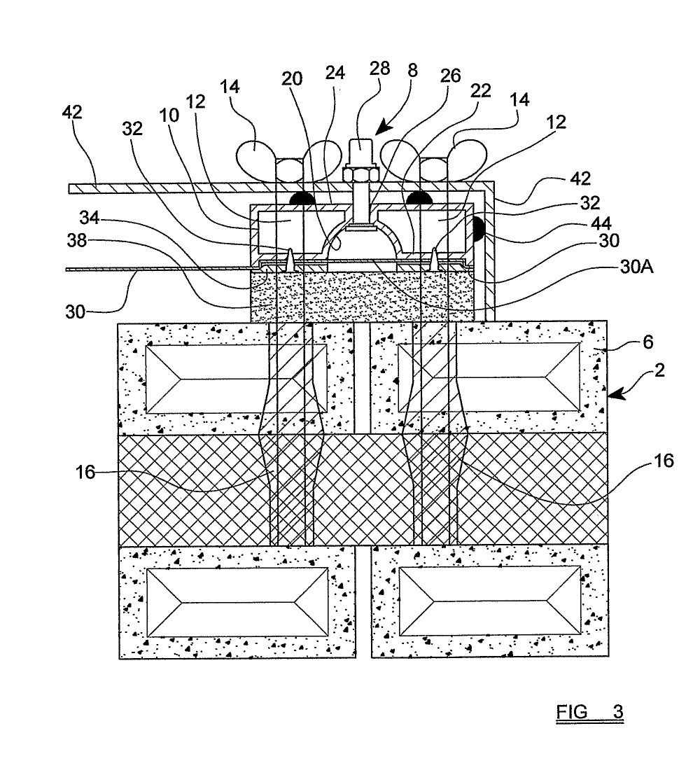

FIG. 3 is a cross-sectional detail of the barrier of FIG. 1 secured to a wall of the premises;

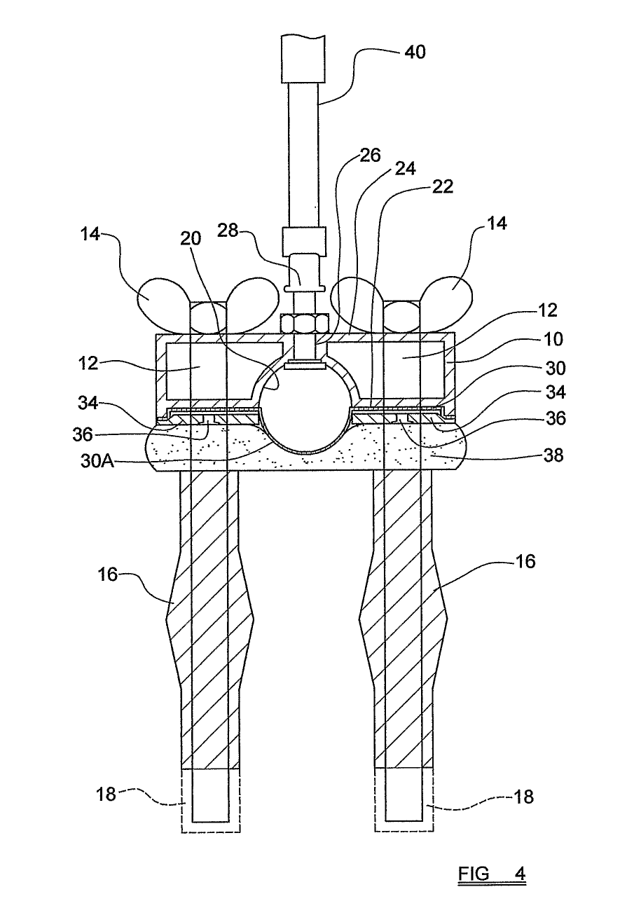

FIG. 4 is a cross-sectional view of part of the barrier of FIG. 1, illustrating sealing thereof to the wall of the premises;

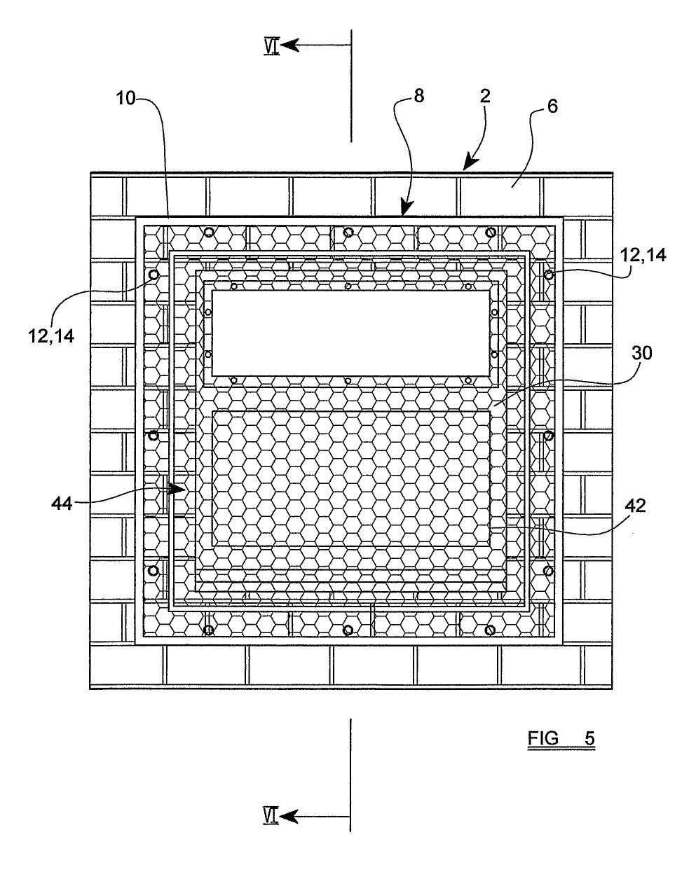

FIG. 5 is a plan view of premises having a window provided with an embodiment of a demountable barrier according to the present invention;

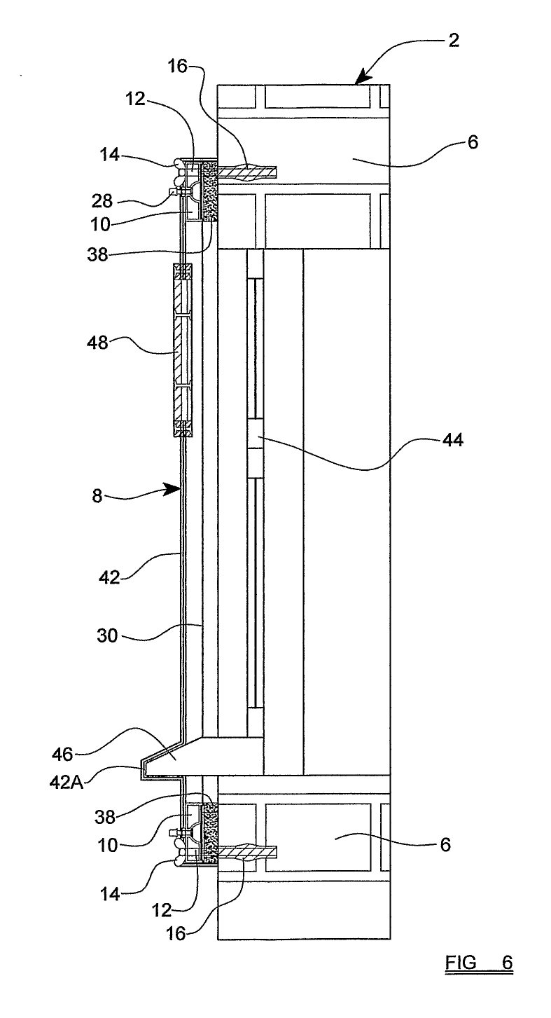

FIG. 6 is a cross-sectional view of the arrangement of FIG. 5;

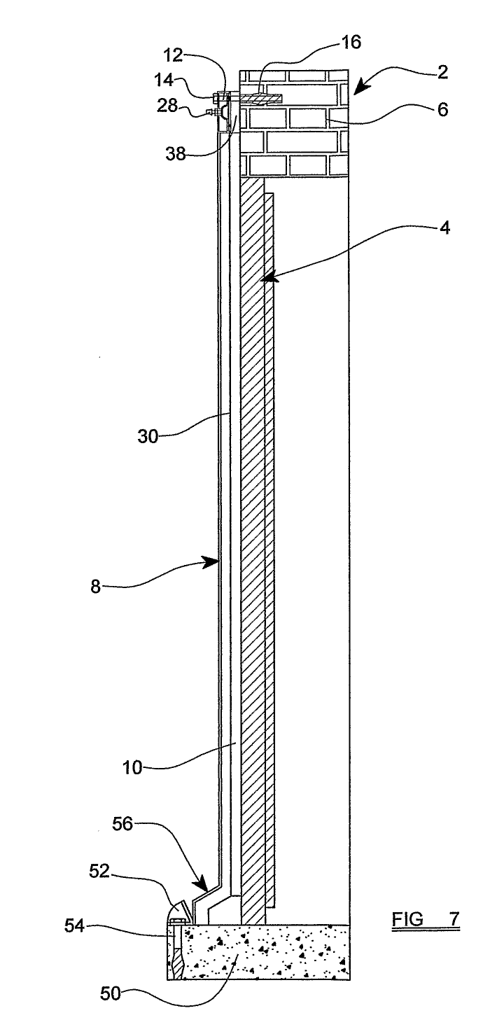

FIG. 7 is a cross-sectional view of a modification of the premises of FIG. 1, having no wall below the door, and provided with a barrier of the present invention; and

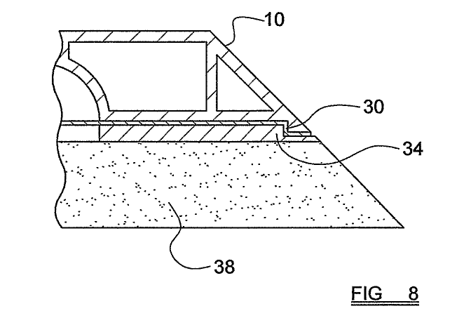

FIG. 8 is a cross-sectional view of a modified profile for the demountable barrier.

Referring to FIGS. 1 to 4, a building premises 2, such as domestic or commercial premises, has an access region in the form of a door 4 provided in a wall 6, such as of brick, stone, wood or other building material.

A demountable barrier 8 according to the present invention is applied to cover the door 4 when required, to substantially prevent or minimise storm or flood water and/or high winds, such as of hurricane, tornado, whirlwind or gale form, from accessing the premises through the vulnerable door 4 and causing damage to the premises 2.

The demountable barrier 8 comprises a substantially rectangular frame member 10 of metal, such as aluminium, which is adapted to be firmly and demountably secured to the wall 6 of the premises 2 by means of bolts 12 conveniently provided with wing nuts 14 and such that the frame member 10 surrounds the door 4. The bolts 12 are suitably provided with expandable securing means 16 which expand when the bolts are inserted into holes 18 drilled in the wall 6 and the nuts 14 tightened. The frame member 10 is thereby tightly secured to the wall 6. When the nuts 14 are loosened, the bolts 12 can be withdrawn from their holes 18 in the wall 6, thereby enabling the frame member 10 to be removed. Instead of providing the bolts 12 with wing nuts 14, the bolts 12 could be of a form having a fixed head, such as a hexagonal-shaped head, replacing the wing nuts 14 and secured and released with a suitable spanner or wrench. The bolts 12 could also be provided with a known form of security locking or anti-tampering arrangement (not shown) to prevent unauthorised removal thereof.

As particularly shown in FIGS. 3 and 4, the frame member 10 has a longitudinal channel 20 provided in a first face 22 thereof and open towards the wall 6 of the premises 2. When the frame member 10 comprises aluminium, the longitudinal channel 20 is suitably formed during an extrusion process used in the manufacture of the frame member 10.

The frame member 10 has a second face 24 opposite to the first face 22 and at least one aperture 26 is provided extending from the second face 24 into the longitudinal channel 20. A non-return air valve 28 is sealed into the or each aperture 26. Such air valve 28 is suitably of a type used for providing inflation of tyres of a vehicle such as a bicycle or car and allows air to be released when suitable actuating means is operated.

A resilient membrane 30 is provided, secured to the frame member 10 and overlying and framed by the frame member 10. The resilient membrane 30 is arranged to overlie and close the longitudinal channel 20. The resilient membrane 30 may be stretched over the frame member 10. The resilient membrane 30 suitably comprises a sheet of plastics material, such as polypropylene and suitably has a thickness of from about 2.5 mm to about 3 mm.

The resilient membrane 30 is secured to the frame member 10 at either side of the longitudinal channel 20 by screws 32, to substantially sealingly close the longitudinal channel 20. The resilient membrane 30 is suitably overlain by one or more strips 34, suitably of metal such as aluminium, having holes 36 therein through which the screws 32 pass and enhance the securing of the resilient membrane 30 and the sealing of the longitudinal channel 20 by the resilient membrane 30.

A compressible sealing member 38 is provided between the frame member 10 and the wall 6 of the premises 2 and overlying the resilient membrane 30 at the region of the frame member 10. The compressible sealing member 38 suitably comprises natural or synthetic rubber material and may particularly comprise neoprene, with a thickness of about 40 mm.

With the frame member 10 of the resulting barrier 8 secured to the wall 6 of the premises 2 by the bolts 12 and nuts 14, an air pump 40 is connected to the or each non-return valve 28 and operated to provide pressurised air in the longitudinal channel 20 and effecting ballooning of a region 30A of the resilient membrane 30 as shown in FIG. 4. This causes compression of the compressible sealing member 38 against the wall 6 to effect a substantially water- and/or air-tight seal between the frame member 10 of the barrier 8 and the wall 6.

The air pump 40 may comprise a manual or automated air pump, such as a pump provided for inflating vehicle tyres. The manual air pump may be a bicycle tyre pump or a foot-operated pump.

The resilient membrane 30 may be susceptible to mechanical damage under very severe weather conditions, although it may subsequently be replaced relatively easily. Damage to the resilient membrane 30 can be prevented by providing a protective cover means 42, as particularly shown in FIGS. 2 and 3. The protective cover means 42 is suitably formed of or from a relatively rigid sheet material, such as a plastics material, which may be reinforced with fibres, such as glass fibres and/or may be vacuum formed or moulded. It is suitably provided of a box-like shape for enclosing the barrier 8 and is secured to the frame member 10 of the barrier 8 such as by a mastic material 44, for example a silicone mastic material. Apertures are suitably provided in the protective cover means 42 to accommodate the or each non-return valve 28 and the securing bolts 12 with their wing nuts or heads 14.

The barrier 8 is relatively light in weight and, after the initial installation procedures, can be subsequently readily fitted to the door 4 without the need for tools, other than a pump, such as a bicycle pump.

The frame member 10 is custom made to suit each particular access region of the premises 2, such as the door 4.

As shown in FIGS. 5 and 6, the barrier 8 is equally applicable to a window 44 in the wall 6 of the premises 2. The barrier 8 for the window 44 is constructed in substantially the same manner as that described with reference to FIGS. 3 and 4, for the door 4.

The window 44 may have a protruding sill 46 over which the resilient membrane 30 is arranged to pass. The protective cover means 42 is also suitably formed with a protruding portion 42A arranged to fit over the sill 46 of the window 44.

When the resilient membrane 30 and/or the protective cover means 42 comprises a non-transparent and/or non-translucent material, it may be desirable, as shown in FIGS. 5 and 6, to provide the barrier 8 with one or more transparent and/or translucent window-like panels 48 therein to allow light to enter the premises 2 and/or visibility into and/or out of the premises 2. This may be particularly important for the barrier 8 applied to the window 44, but is also applicable to the barrier 8 applied to the door 4.

The one or more transparent and/or translucent window-like panels 48 may be incorporated in and sealed into the protective cover means 42 and/or the resilient membrane 30 and may suitably comprise a clear polycarbonate material. A suitable thickness for such a window-like panel 48 of clear polycarbonate material incorporated in the protective cover means 42 is about 12 mm.

Referring again to FIGS. 1 and 2, the barrier 8 is there shown fitted to the door 4 in the premises 2 in which a region 6A of the wall 6 is provided below a lower edge region of the door 4. A lower portion 10A of the frame member 10 is secured and sealed to this region 6A of the wall 6.

As shown in FIG. 7, a door 4 is provided in the wall 6 of the premises 2, such that there is no region of the wall 6 underlying the lower edge region of the door 4, a base region 50 of the premises 2 being provided below the lower edge region of the door 4. In this case, in order to accommodate the barrier 8, a strip-form member 52, in the form of a weather strip, is provided, which is sealed and secured to the base region 50 of the premises 2 by means of bolts 54. The strip-form member 52 suitably comprises metal such as aluminium. A lower region 56 of the barrier 8 is adapted to be slotted into and rocked tightly into engagement with the strip-form member 52 and the barrier 8 is then secured to the wall 6 by the bolts 12 and nuts 14 as previously described. The membrane 30 is trapped in the strip-form member 52.

As shown in FIG. 8 the cross-sectional configuration of the frame member 10 may be modified to incorporate a chamfer on the external edge thereof.

The chamfer allows flood water to pass the barrier with less turbulence and so reduces the likelihood of water penetrating the barrier. FIG. 8 also shows that the compressible sealing member 38 may be similarly chamfered to further reduce turbulence.

1. A demountable barrier (8) for substantially preventing or minimising access of air and/or water into premises (2) through an access region (4) provided in a wall (6) of the premises, wherein the barrier (8) comprises: a frame member (10) adapted to be firmly secured to the wall of the premises and surrounding the access region, the frame member having a longitudinal channel (20) therein in a first face (22) thereof open towards the wall of the premises; a resilient membrane (30) secured to the frame member and framed by the frame member and overlying and closing the longitudinal channel; at least one non-return air valve means (28) extending to the longitudinal channel from a second face (24) of the frame member and sealed through at least one aperture provided in the frame member; a compressible sealing member (38) adapted to be located between the frame member and the wall of the premises; and pump means (40) to provide pressurised air into the longitudinal channel through the at least one non-return air valve means, to effect ballooning of the resilient membrane overlying the longitudinal channel and compression of the compressible sealing member, whereby a substantially water- and/or air-tight seal is effected between the frame member and the wall.

2. A demountable barrier as claimed in claim 1, wherein the second face (24) of the frame member (10) is opposite to the first face (22) of the frame member.

3. A demountable barrier as claimed in claim 1, wherein the frame member (10) is of substantially rectangular form.

4.-6. (canceled)

7. A demountable barrier as claimed in claim 1, wherein the frame member (10) is demountably secured to the wall (6) of the premises (2) by threaded fastener means (12).

8. (canceled)

9. A demountable barrier as claimed in claim 7, wherein the threaded fastener means (12) comprise expandable securing means (16).

10. (canceled)

11. A demountable barrier as claimed in claim 7, wherein the threaded fastener means (12) incorporates security locking means.

12. A demountable barrier as claimed in claim 1, wherein the resilient membrane (30) comprises a sheet of plastics material.

13.-14. (canceled)

15. A demountable barrier as claimed in claim 1, wherein the resilient membrane (30) is stretched over the frame member (10).

16. A demountable barrier as claimed in claim 15, wherein the resilient membrane (30) is secured to the frame member (10) at either side of the longitudinal channel (20) to substantially sealingly close the longitudinal channel.

17. (canceled)

18. A demountable barrier as claimed in claim 16, wherein the resilient membrane (30) is overlain by at least one strip (34) where secured to the frame member (10), threaded fasteners (32) being provided extending through the at least one strip and the resilient membrane and into the frame member.

19.-29. (canceled)

30. A demountable barrier as claimed in claim 1, wherein an external edge of the frame member (10) is chamfered.

31. A demountable barrier as claimed in claim 1, wherein an external edge of the compressible sealing member (38) is chamfered.

32. A demountable barrier as claimed in claim 1, wherein protective cover means (42) is provided for the demountable barrier (8) and formed of or from a relatively rigid sheet material.

33. (canceled)

34. A demountable barrier as claimed in claim 32, wherein the relatively rigid sheet material (42) is reinforced with fibres.

35.-37. (canceled)

38. A demountable barrier as claimed in claim 32, wherein the protective cover means (42) is provided of a box-like shape for enclosing the barrier (8).

39. A demountable barrier as claimed in claim 32, wherein the protective cover means (42) is secured to the frame member (10) of the barrier (8).

40. A demountable barrier as claimed in claim 39, wherein the protective cover means (42) is secured to the frame member (10) of the barrier (8) by means of a mastic material (44).

41. (canceled)

42. A demountable barrier as claimed in claim 32, wherein when at least one of the resilient membrane (30) and the protective cover means (42) comprises material selected from a non-transparent material and a non-translucent material, at least one window-like panel of material selected from transparent and translucent material is sealedly incorporated therein.

43.-44. (canceled)

45. A demountable barrier as claimed in claim 1, wherein when the access region (4) of the premises (2) has no wall (6) of the premises below a lower edge region thereof, the frame member (10) is adapted to cooperate along a lower edge thereof with a strip-form member (52) which is adapted to be sealedly secured to a base region (50) of the premises below the access region.

46.-49. (canceled)
